(19) United States
(12) Patent Application Publication
(10) Pub. No.: US 2016/0035490 A1
(43) Pub. Date: Feb. 4, 2016

(54) COMPOSITE OXIDE-COATED METAL POWDER, PRODUCTION METHOD THEREFOR, CONDUCTIVE PASTE USING COMPOSITE OXIDE-COATED METAL POWDER, AND MULTILAYER CERAMIC ELECTRONIC COMPONENT

(71) Applicant: MURATA MANUFACTURING CO., LTD., Nagaokakyo-shi (JP)

(72) Inventors: Akihiro Tsuru, Nagaokakyo-shi (JP); Toru Nakanishi, Nagaokakyo-shi (JP)

(21) Appl. No.: 14/883,677

(22) Filed: Oct. 15, 2015

Related U.S. Application Data
(63) Continuation of application No. PCT/JP2014/055984, filed on Mar. 7, 2014.

(30) Foreign Application Priority Data
Apr. 17, 2013 (JP) 2013-086949

(51) Int. Cl. H01G 4/12; H01G 4/012; H01G 4/008; B22F 1/02; H01B 1/22; H01G 4/30; B22F 1/00

(52) U.S. Cl. CPC H01G 4/1227; H01G 4/30; H01G 4/012; B22F 1/0003; B22F 1/02; H01B 1/22; H01G 4/0085

(57) ABSTRACT

A method for producing a composite oxide-coated metal powder that includes a first step of coating a metal powder with a metal oxide by a hydrolysis reaction of a water-soluble metal compound in an aqueous solvent, and a second step of turning the metal oxide into a composite oxide. In the first step, the water-soluble metal compound containing a tetravalent metal element dissolved in a solvent including at least water is added to a slurry including the metal powder dispersed in the solvent to deposit the metal oxide containing the tetravalent metal element and produce a metal oxide-coated metal powder slurry. In the second step, a solution or powder containing at least one divalent element is added to the metal oxide-coated metal powder slurry to react the metal oxide present on the surface of the metal powder with the divalent element, thereby providing the composite oxide-coated metal powder.

### CROSS REFERENCE TO RELATED APPLICATIONS

The present application is a continuation of International application No. PCT/JP2014/055984, filed Mar. 7, 2014, which claims priority to Japanese Patent Application No. 2013-086949, filed Apr. 17, 2013, the entire contents of each of which are incorporated herein by reference.

### FIELD OF THE INVENTION

The present invention relates to a composite oxide-coated metal powder that is a powder of a metal powder coated with a composite oxide, a production method therefor, a conductive paste using the composite oxide-coated metal powder, and a multilayer ceramic electronic component, and more particularly, relates to a metal powder for use in, for example, a multilayer ceramic electronic component such as a multilayer ceramic capacitor.

### BACKGROUND OF THE INVENTION

Conventionally, multilayer ceramic capacitors are manufactured by applying a conductive paste composed of a metal powder for constituting electrode layers to dielectric sheets for dielectric layers, stacking the sheets, and then integrally combining the sheets through a firing step. More specifically, dielectric raw materials are prepared, made into the form of a paste, and made into sheets. To the dielectric sheets, a conductive paste is applied which serves as internal electrodes, and the sheets are stacked, and subjected to pressure bonding. Thereafter, the pressure-bonded body is subjected to sintering to integrally combine the dielectric layers and the electrode layers, thereby providing a multilayer ceramic capacitor. With the reduction in size and the increase in capacitance for multilayer ceramic capacitors in recent years, a reduction in thickness is required for the electrode layers, and in order to achieve this reduction, metal powders for conductive pastes are required to be microparticulated and highly dispersed.

The metal powders of the conductive pastes for use in multilayer ceramic capacitors are also required to have resistance to sintering. The sintering temperatures of the metal powders for use in the conductive pastes are approximately 400° C., whereas the temperatures at which dielectrics are sintered are approximately 1000° C. In firing steps for multilayer ceramic capacitors, there is a need for both dielectric layers and electrode layers to be sintered, and the layers are thus subjected to firing at the sintering temperature of the dielectric layers which require the higher sintering temperature. However, the difference in sintering shrinkage behavior, which results from the difference in sintering behavior between the dielectric layers and the electrode layers as described above, causes the capacitor to be cracked, and causes the coverage to be decreased. For this reason, for the purpose of bringing the sintering shrinkage behavior of the dielectric layers close to that of the electrode layers, dielectric microparticles are mixed in the electrode layers to keep the metal powder from being sintered.

As a model of keeping from being sintered, it is believed that the presence of the dielectric microparticles between the metal particles and at grain boundaries keeps the metal powder from necking, and from being sintered. Thus, as long as metal powder surfaces are kept from coming into contact with each other, it is possible to further keep from being sintered. As long as there is ideally a metal powder coated uniformly with the dielectric in order to keep the metal powder surfaces from coming into contact with each other, the sintering suppression effect is believed to be high.

Attempts have been made so far to form, by liquid-phase syntheses, dielectric composite oxide layers on surfaces of metal powders. Japanese Patent Application Laid-Open No. 2006-4675 (hereinafter, referred to as “Patent Document 1”) discloses a production method in which an organic solvent of slurry obtained by adding metal alkoxides 114, 116 to slurry of a Ni powder 112 dispersed in an organic solvent is evaporated for drying to react the metal alkoxides 114, 116 during the drying, for the purposes of bringing heat shrinkage characteristics of a Ni powder close to those of ceramic dielectric layers, and obtaining a conductive particle powder that has excellent oxidation resistance and dispersibility in conductive coatings (see FIG. 2 of Patent Document 1).

However, in the production method described in Patent Document 1, because of the use of the metal alkoxides 114, 116 which are extremely likely to be hydrolyzed, the reaction control is difficult, and the metal oxide 134 is likely to be produced in the solution before the surface of the Ni powder 112 is coated with the metal oxide 134. In addition, because of being reacted during organic solvent drying, the reaction proceeds while increasing the concentrations of the metal alkoxides 114, 116. Therefore, the reaction differs between the beginning and end of the reaction, and it is difficult to keep homogeneity in the system. In addition, as for the reaction sites, the reaction is developed not only at the particle surfaces but also in the solution other than around the particle surfaces, because the metal constituents which can turn into two types of oxides are added at the same time. The reactant in the solution adheres to the Ni powder 112 in the drying process, thereby failing to form uniform coating layers. Moreover, the production method described in Patent Document 1 is costly in explosion proof, etc. for the solvent and the production apparatus, because of the reaction system in the organic solvent.

In addition, Japanese Patent Application Laid-Open No. 2000-282102 (hereinafter, referred to as “Patent Document 2”) discloses a production method of developing a hydrolysis reaction of a metal salt through the addition of an aqueous solution of the metal salt which can turn into a composite oxide to a metal powder slurry, and then the addition of an alkali 222, thereby providing a Ni powder 232 coated with an oxide 234 (see FIG. 3 of Patent Document 2).

However, in the production method, the reaction for the production of the oxide 234 is controlled by the addition of the alkali 222, and the reaction for the production of the oxide 234 is excessively rapid, thereby developing the reaction not only at the surfaces of particles 212 but also at sites other than around the surfaces of the particles 212 in the solution. For this reason, the production method is not enough to obtain the Ni powder 232 coated uniformly with the oxide 234, because the reaction product at the sites other than around the surfaces of the particles 212 also adheres to the metal powder 212 in the drying process in the method.

Patent Document 1: Japanese Patent Application Laid-Open No. 2006-4675

Patent Document 2: Japanese Patent Application Laid-Open No. 2000-282102

### SUMMARY OF THE INVENTION

An object of the present invention is to provide a method for producing a composite oxide-coated metal powder coated with a composite oxide in an extremely uniform fashion.

The production method according to the present invention includes a first step of coating a metal powder with a metal oxide, and a second step of turning the metal oxide coating the metal powder surface into a composite oxide.

In the specification of the present application, “a powder of a metal powder coated with a metal oxide” is defined as “a metal oxide-coated metal powder”, whereas “a powder of a metal powder coated with a composite oxide” is defined as “a composite oxide-coated metal powder”.

The method for producing a composite oxide-coated metal powder according to the present invention includes: a first step of adding a water-soluble metal compound containing a tetravalent metal element that is dissolved in a solvent including at least water to a first slurry including the metal powder dispersed in the solvent to deposit a metal oxide containing the tetravalent metal element and thereby provide a second slurry containing a metal oxide-coated metal powder; and a second step of adding a solution or a powder containing at least one divalent element to the second slurry so as to react with the metal oxide present on the surface of the metal oxide-coated metal powder and provide the composite oxide-coated metal powder.

The production method according to the present invention uses, as the metal compound added for depositing a metal oxide on the metal powder surface, the water-soluble metal compound dissolved in the solvent including water, thereby making it possible for the reaction of metal oxide deposition to proceed gradually. For this reason, a metal powder is obtained which is coated uniformly with the metal oxide, because oxides can be kept from being produced at sites other than the metal powder surface.

In addition, the reaction for producing the composite oxide is allowed to proceed near the metal powder surface by separately carrying out the step of coating the metal powder surface with the oxide and the step of turning the coating oxide into the composite oxide, and a composite oxide-coated metal powder is thus obtained which is coated more uniformly with the composite oxide.

Furthermore, the reaction is developed in the solvent including water, and thus advantageous in terms of cost as compared with production methods carried out in organic solvents.

In the production method, the metal powder is desirably a metal powder in which the ratio of the metal element in a hydroxide state falls within the range of 30% to 100%, the ratio being obtained by peak separation of the metal element in a metal state, the metal element in an oxide state, and the metal element in the hydroxide state in an X-ray photoelectron spectroscopy analysis.

The OH groups at the metal powder surface cause the hydrolysis reaction of the water-soluble metal compound to proceed more selectively on the metal powder surface, thus providing a more uniform metal oxide-coated film.

In the production method, the water-soluble metal compound is preferably a chelate complex.

The water-soluble metal compound is preferred for the present production method, and excellent in stability and reaction controllability, thus providing a more uniform oxide-coated metal powder.

In the production method described above, the water-soluble metal compound is preferably a metal compound with at least one of a hydroxycarboxylic acid, an aminoalcohol, and an aminocarboxylic acid coordinate. These metal compounds are mildly reactive unlike metal alkoxides that are likely to be hydrolyzed, thus allowing the reaction of metal oxide deposition, that is, the hydrolysis reaction to proceed gradually, and allowing a more uniform metal oxide film to be formed.

In the second step of the production method, the temperature for reacting the metal oxide present on the surface of the metal powder in the metal oxide-coated metal powder with the divalent element is desirably 60° C. or higher. This makes the reaction for forming the composite oxide more likely to proceed.

In the production method, the tetravalent metal element of the composite oxide is preferably Zr and/or Ti. These tetravalent metal elements are more likely to form the composite oxide, also used for dielectric compositions, and less likely to influence compositional deviations.

In the production method, the divalent element contained in the solution or the powder added in the second step preferably includes at least one of Mg, Ca, Sr, and Ba. These divalent elements are more likely to produce the composite oxide, and component characteristics can be kept from deteriorated, by selecting the divalent element added, for example, depending on the composition of a dielectric layer.

In at least one step of the first step, second step, and other step between the first step and the second step, a solution or a powder containing at least one element of rare-earth elements, Mn, Si, and V is desirably added to the metal powder to cause the at least one element of the rare-earth elements, Mn, Si, and V to be contained in the composite oxide layer formed by coating the metal powder surface with the composite oxide.

The element which may be added to dielectric layers, as well as the element also included in the composite oxide layer further reduce compositional deviations. In addition, the addition of the element can control properties such as sinterability of the oxide coated layer and resistance thereof to reduction.

In the production method, the constituent ratio of the composite oxide is desirably 0.5 mol % to 10 mol % when the metal powder is regarded as 100 mol %. The sintering suppression effect is not enough when the constituent ratio of the composite oxide is low, whereas the proportion of the metal in electrode layers is decrease to decrease the coverage of internal electrodes when the constituent ratio is high. For this reason, limiting the constituent ratio as just described can achieve a sintering suppression effect that is enough to keep the coverage of internal electrodes from being decreased.

In the production method, the metal powder is preferably 0.01 μm to 1 μm in particle size.

The metal powder of 0.01 μm or less in particle size is too small in particle size to coat the entire metal powder uniformly with the composite oxide, and the sintering suppression effect is thus decreased to decrease the coverage. In addition, even when the amount of the coating layer on the powder surface is increased, the proportion of the metal in electrode layers is decreased, and chip characteristics are thus deteriorated. With the metal powder of 1 μm or more in particle size, the coverage is high even without the composite oxide for keeping from being sintered, and there is no need to keep from being sintered.

In the production method, at least one of the elements included in the metal powder is preferably Ni, Ag, Cu, or Pd. The metal powder including the elements is used in a preferred fashion for multilayer ceramic electronic component.

The present invention encompasses a composite oxide-coated metal powder produced by the production method described above. The metal powder is preferred for multilayer ceramic electronic components.

The present invention encompasses a conductive paste including: a composite oxide-coated metal powder obtained by the production method; and an organic vehicle.

The present invention encompasses a multilayer ceramic electronic component including a plurality of ceramic layers and internal electrode layers provided between the respective layers from the plurality of ceramic layers, where the internal electrode layers are obtained by sintering a conductive paste including a composite oxide-coated metal powder obtained by the production method.

The production method according to the present invention can produce the composite oxide-coated metal powder coated with the composite oxide in an extremely uniform fashion, and thus improve the sintering suppression effect for the metal powder.

### BRIEF EXPLANATION OF THE DRAWINGS

FIG. 1 illustrates a pattern diagram of an embodiment according to the present invention.

FIG. 2 illustrates a pattern diagram of an embodiment according to Patent Document 1.

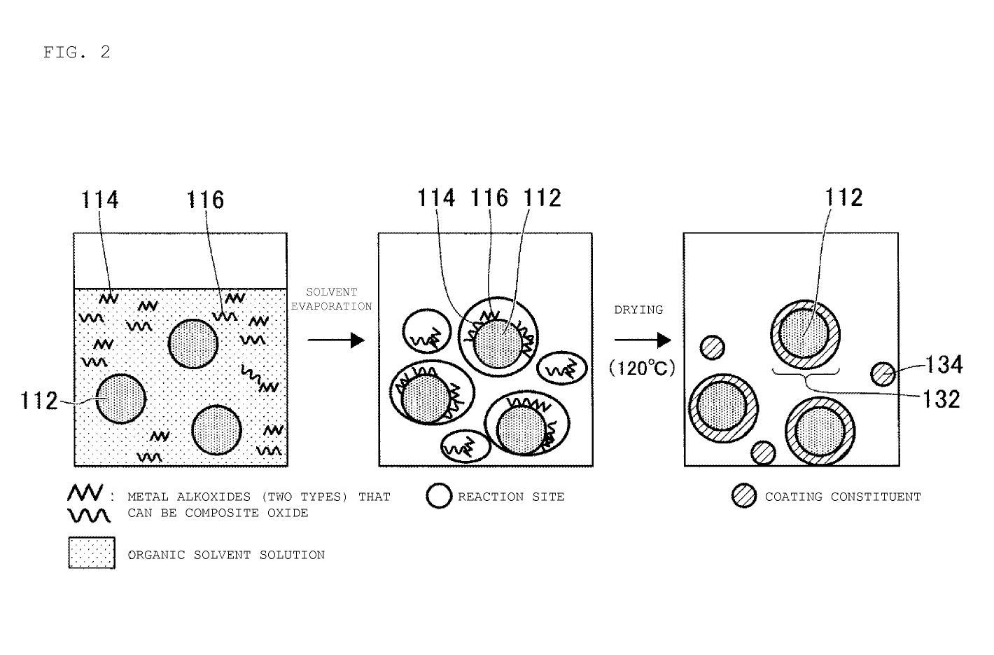

FIG. 3 illustrates a pattern diagram of an embodiment according to Patent Document 2.

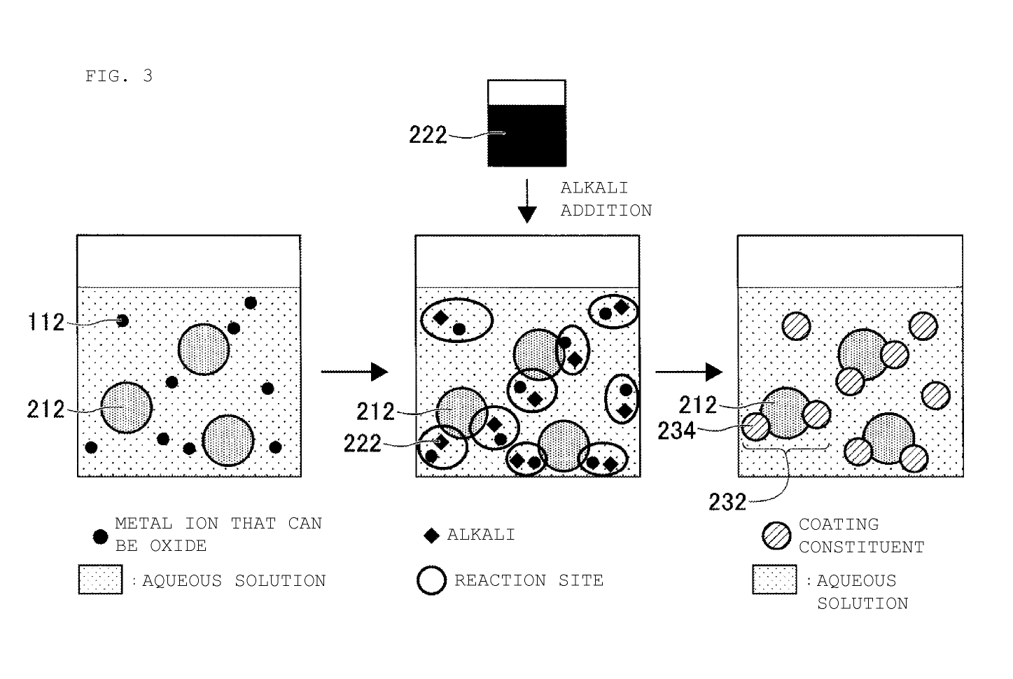

### DETAILED DESCRIPTION OF THE INVENTION

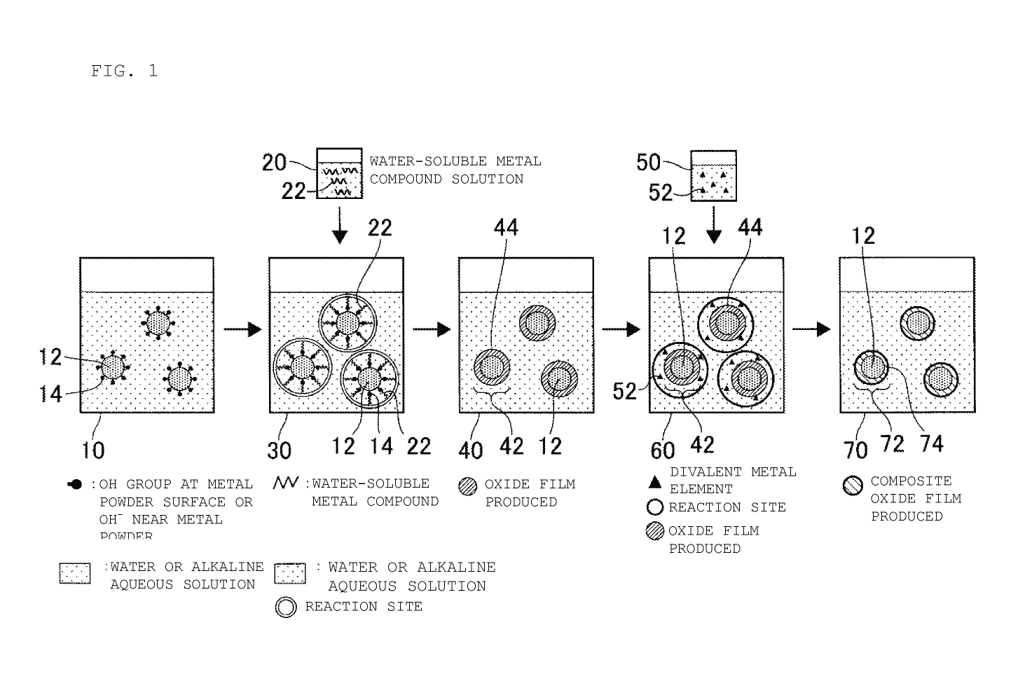

An embodiment of a method for producing a metal powder according to the present invention will be described below with reference to FIG. 1.

### First Step

First, a metal powder 12 is mixed in a solvent including at least water to obtain metal powder slurry 10. To this slurry 10, a water-soluble metal compound 22 containing a tetravalent metal element, or a solution 20 containing the compound is added to deposit, on the surface of the metal powder 12, a metal oxide 44 containing the tetravalent metal element, thereby providing a metal oxide-coated metal powder 42 with the surface of the metal powder 12 at least partially coated with the metal oxide 44.

In the first step, the metal powder 12 included in the slurry 10 is desirably the metal powder 12 in which the ratio of the metal element 14 in a hydroxide state falls within the range of 30 to 100%, the ratio being obtained by peak separation of the metal element in a metal state, the metal element in an oxide state, and the metal element 14 in the hydroxide state in an X-ray photoelectron spectroscopy analysis.

In addition, in the first step, the concentration of the water-soluble metal compound 22 in the solution 20 in which pure water is mixed with the water-soluble metal compound 22 is desirably lower in order to inhibit local reactions in mixing, when the water-soluble metal compound 22 is hydrolyzed to produce the metal oxide 44. Preferably the aqueous solution 20 of 1 to 40 wt % water-soluble metal compound is used.

Furthermore, in the first step, the solution 20 in which pure water is mixed with the water-soluble metal compound 22 may be added in stages to the metal powder slurry 10, and the concentration may differ for each stage.

### Second Step

Furthermore, a solution 50 or a powder containing at least one divalent element 52 is added to the slurry 40 of the metal oxide-coated metal powder 42, which is obtained in the first step. Then, the metal oxide 44 containing the tetravalent metal element, which is present on the surface of the metal powder 12, is reacted with the divalent element 52 to turn the metal oxide 44 into a composite oxide 74, thereby providing a composite oxide-coated metal powder 72 coated with the composite oxide 74.

In the second step, the addition method for the divalent element 52 may add the element not only as a homogeneous solution, but also in the form of slurry or powder.

In addition, in the second step, the composite oxide 74 coating the metal powder 12 is not required to be a perfect crystal, but may have two or more oxides mixed on the order of nm to adhere to the metal powder 12.

The production method according to the present invention provides the composite oxide-coated metal powder 72 coated uniformly with the composite oxide 74 through the first step of coating the metal powder 12 with the metal oxide 44 by a hydrolysis reaction of the water-soluble metal compound 22 in an aqueous solvent, and the second step of turning the metal oxide 44 deposited on the surface of the metal powder 12 into a composite oxide.

When a metal alkoxide is used in order to deposit a metal oxide on the surface of the metal powder, the metal alkoxide is extremely likely to be hydrolyzed, and a metal oxide is thus more likely to be produced at sites other than the surface of the metal powder, thereby leading to interference with homogeneity of a composite oxide produced on the surface of the metal powder. However, according to the present invention, in the first step, the water-soluble metal compound 22 is added as the metal compound added for depositing the metal oxide 44 on the surface of the metal powder 12, thus allowing the hydrolysis reaction to proceed gradually, depositing the metal oxide 44 uniformly on the surface of the metal powder 12 while keeping the metal oxide 44 from being produced at sites other than the surface of the metal powder 12, and as a result, providing the composite oxide-coated metal powder 72 coated uniformly with the composite oxide 74.

In addition, the OH groups 14 at the surface of the metal powder 12 and the OH⁻ 14 near the metal powder make the hydrolysis reaction of the water-soluble metal compound 22 more likely to proceed near the surface of the metal powder 12. The use of, as the metal powder 12 coated with the metal oxide 44, for example, the metal powder 12 with the many OH groups 14 at the surface or the metal powder 12 immersed in an alkaline aqueous solution to provide the surface with the OH groups 14 further keeps the metal oxide 44 from being produced at sites other than the surface of the metal powder 12, thereby further improving the homogeneity of the composite oxide 74 coating the surface of the metal powder 12.

It is to be noted that the solvent is desirably aqueous within a pH range in which the metal powder 12 to be coated is not dissolved. The hydrolysis reaction of the water-soluble metal compound 22 is allowed to proceed by various methods, and the method is desirably selected depending on the properties of the metal powder 12 and water-soluble metal compound 22 used. For example, due to the fact that nickel powder is likely to be dissolved in acid, a method is preferred in which an alkaline aqueous solution is used to proceed with coating by a hydrolysis reaction with hydroxide ions (OH⁻), and in the case of this method, the alkali aqueous solution provides the surface of the nickel powder with OH groups, thus allowing the hydrolysis reaction of the water-soluble metal compound to proceed closer to the surface, and as a result, allowing a metal oxide-coated film to be formed on the surface of the nickel powder in a more uniform fashion.

In addition, in the production method according to the present invention, the step of coating the metal powder 12 with the composite oxide 74 is divided into two stages: a first step of coating the metal powder 12 with the metal oxide 44 by a hydrolysis reaction of the water-soluble metal compound 22 in an aqueous solvent; and a second step of turning the metal oxide 44 coating the surface of the metal powder 12 into the composite oxide 74. Thus, the reaction for the production of the composite oxide 74 is allowed to proceed near the surface of the metal powder 12, and as a result, providing the composite oxide-coated metal powder 72 coated with the composite oxide 74 in a more uniform fashion.

Furthermore, the production method according to the present invention, in which an aqueous solvent is used, is advantageous in terms of cost in that the solvent is inexpensive and that there is no need for any explosion-proof equipment, as compared with a method in which an organic solvent is used.

The production method according to the present invention allows more highly homogeneous coating than the prior art, thereby achieving a multilayer ceramic capacitor which has a sintering suppression effect improved, and keeps the coverage from being decreased in firing.

Examples of the method for producing a composite oxide-coated metal powder according to the present invention and comparative examples for comparison with the production method according to the present invention will be described below.

### Example 1-1 to Example 1-6

### First Step

Metal powder slurry was obtained by mixing 5 g of a nickel powder of 0.2 μm in average particle size and 95 g of a 0.05 M aqueous solution of sodium hydroxide. While agitating the slurry, 20 g of a 5 wt % aqueous solution of titanium diisopropoxybis(triethanolaminate) was gradually added thereto as a water-soluble metal compound of a tetravalent metal element to form an oxide coating layer of TiO₂ on the metal powder surface.

### Second Step

After increasing the temperature of the reaction liquid from 25° C. to 60° C., the oxide layer of TiO₂ was turned into a composite oxide to form a composite oxide layer of BaTiO₃ by adding a 5 wt % aqueous solution of barium hydroxide (Example 1-1, Example 1-4), a 5 wt % aqueous solution of barium acetate (Example 1-2, Example 1-5), or a 5 wt % aqueous solution of barium lactate (Example 1-3, Example 1-6) as a divalent element so that barium was 1 molar equivalent or more with respect to titanium, and carrying out washing and drying.

The coating method of forming an oxide coating layer and then turning the oxide coating layer on the metal powder surface into a composite oxide, thereby providing a composite oxide-coated layer as just described is referred to as a method 1.

### Comparative Example 1-1

Comparative Example 1-1 consists in a nickel powder before undergoing the first step and the second step, that is, a nickel powder without any composite oxide.

### Comparative Example 1-2

Acetone slurry was obtained by mixing 50 g of a nickel powder of 0.2 μm in average particle size and 50 g of acetone. The slurry was agitated and mixed for 60 minutes with the addition of, to the slurry, 20 ml of an acetone solution with 6.09 g of titanium tetraisopropoxide dispersed therein and 20 ml of an acetone solution with 5.48 g of barium diisopropoxide dispersed therein. The mixed solution obtained was dried in air for 3 hours in a draught, and then dried for 60 minutes at 80° C. to obtain a composite oxide-coated metal powder according to Comparative Example 1-2. This production method is referred to as a method 2.

### Comparative Example 1-3

Slurry was obtained by mixing 50 g of a nickel fine powder and 500 ml of pure water. While keeping the solution at 60° C., 9.6 g of titanium sulfate (product with Ti: 5 weight %) was added at once to the slurry, and an aqueous solution of sodium hydroxide (NaOH: 1 N) was added to adjust the pH to 8. After agitating as it was for 1 hour, a metal oxide-coated metal powder with TiO₂ adhering thereto was obtained through filtration and drying. This production method is referred to as a method 3.

### Comparative Example 1-4

To butanol, a 5.41 M aqueous solution of TiCl₄ and a 5 M aqueous solution of BaCl₂ were added to prepare 54 ml of a 0.1 M TiCl₄-0.1 M BaCl₂ alcohol solution. Then, diethylamine was added to butanol to prepare 240 ml of a 0.2 M butanol solution of diethylamine. To the 0.2 M butanol solution of diethylamine, 3.43 g of a Ni powder of 350 nm in average particle size was added, and agitated to disperse the Ni powder, and the 0.1 M TiCl₄-0.1 M BaCl₂ alcohol solution was then further added to the solution. After the addition, a composite oxide-coated metal powder was obtained by continuing agitation for 24 hours while proceeding with a coating reaction. This production method is referred to as a method 4.

It is to be noted that the contents of composite oxides included in the various types of coated powders prepared was determined by ICP-AES, and calculated as the Ti molar quantity with respect to Ni.

### Preparation of Multilayer Ceramic Capacitor

The metal powders obtained according to the examples and comparative examples described above were used to prepare conductive pastes, and the conductive pastes were used to prepare multilayer ceramic capacitors.

The conductive pastes to serve as electrode layers of multilayer ceramic capacitors were prepared in such a way that the metal powders, a resin, a dispersive material, and a solvent were mixed, and then subjected to dispersion treatment with the use of a triple roll mill, a sand mill, or a pot mill to make paste form. The multilayer ceramic capacitors have dielectric layers based on any of MgTiO₂, MgZrO₂, CaTiO₃, CaZrO₃, BaTiO₃, BaZrO₃, SrTiO₃, and SrZrO₃, and containing a sintering aid such as SiO₂, a rare earth for adjusting electrical characteristics, an alkaline earth, Mn, V, etc. It is green sheets that were formed from slurry made from the mixture with a resin and a solvent. Conductive coating films of 0.5 μm in equivalent film thickness based on XRF analysis were formed on the green sheets with the use of the conductive pastes obtained from the metal powders. The ceramic green sheets with the internal electrode coating films applied were peeled from the PET film, and the ceramic green sheets were then stacked, put into a predetermined mold, and pressed. Then, this pressed laminate block was cut into a predetermined size, thereby providing raw laminates in a chip form to serve as individual multilayer ceramic capacitors. These raw laminates were subjected to degreasing treatment for 10 hours at a temperature of 350° C. in nitrogen, and then to firing treatment in accordance with a profile of keeping for 1 hour at a temperature of 1200° C. with an oxygen partial pressure of 10⁻⁸ to 10⁻⁹ MPa in a mixed atmosphere of N₂/H₂/H₂O. Further, the multilayer ceramic capacitors prepared were adjusted to 1.0 mm×0.5 mm in size, and to 100 in the number of effective electrode layers.

### Evaluation of Internal Electrode Coverage

The multilayer capacitors prepared as described above were separated at the interfaces between the electrode layers and the dielectric layers, and the proportions of metal parts at the peeled surfaces were calculated as coverages. The differences in sintering shrinkage behavior between the dielectric layers and electrode layers of the multilayer ceramic capacitors cause the coverages to be decreased. For this reason, the increased coverages indicate that the sintering behaviors of the dielectric layers and electrode layers are brought close to each other, with the electrode layers of the multilayer ceramic capacitors kept from being sintered. Table 1 shows the materials used in the respective production methods according to Example 1-1 to Example 1-6 and Comparative Example 1-1 to Comparative Example 1-4, and the results of evaluating the metal powders obtained from the materials. In the columns “Coverage Determination” of Table 1, the coverages of: less than 70%; 70% or more and less than 80%; 80% or more and less than 90%; and 90% or more are respectively expressed as “x”; “Δ”; “◯”; and “⊙”.

TABLE 1

| | | | | | | Minute | Step | | | | | | |
|---|---|---|---|---|---|---|---|---|---|---|---|---|---|
| | | Type | | | | Amount of | of | Solvent | | Type | Com- | | Cov- |
| | | of | Metal | | | Additive | Adding | of | | of | posite | | erage |
| | | Metal | Particle | Group IV | Group | Element | Rare- | Metal | Temper- | Com- | Oxide | Cov- | Deter- |
| | Coating | Par- | Size | Metal | II | Rare Earth | earth | Powder | ature | posite | Content | erage | mina- |
| | Method | ticle | (μm) | Compound | Element | Mn, Si, V | Element | Slurry | (° C.) | Oxide | (mol %) | (%) | tion |
| Exam- | Method | Ni | 0.2 | Titanium | Barium | — | — | Water | 60 | BaTiO₃ | 2 | 86 | ◯ |
| ple | 1 | | | diisopropoxybis | hydroxide | | | | | | | | |
| 1-1 | | | | (triethanol- | | | | | | | | | |
| | | | | aminate) | | | | | | | | | |
| Exam- | Method | Ni | 0.2 | Titanium | Barium | — | — | Water | 60 | BaTiO₃ | 2 | 80 | ◯ |
| ple | 1 | | | diisopropoxybis | acetate | | | | | | | | |
| 1-2 | | | | (triethanol- | | | | | | | | | |
| | | | | aminate) | | | | | | | | | |
| Exam- | Method | Ni | 0.2 | Titanium | Barium | — | — | Water | 60 | BaTiO₃ | 2 | 84 | ◯ |
| ple | 1 | | | diisopropoxybis | lactate | | | | | | | | |
| 1-3 | | | | (triethanol- | | | | | | | | | |
| | | | | aminate) | | | | | | | | | |
| Exam- | Method | Ni | 0.2 | Titanium | Barium | — | — | Water | 60 | BaTiO₃ | 2 | 89 | ◯ |
| ple | 1 | Slurry | | diisopropoxybis | hydroxide | | | | | | | | |
| 1-4 | | by Dis- | | (triethanol- | | | | | | | | | |
| | | persion | | aminate) | | | | | | | | | |
| | | Treat- | | | | | | | | | | | |
| | | ment | | | | | | | | | | | |
| Exam- | Method | Ni | 0.2 | Titanium | Barium | — | — | Water | 60 | BaTiO₃ | 2 | 90 | ⊙ |
| ple | 1 | Slurry | | diisopropoxybis | acetate | | | | | | | | |
| 1-5 | | by Dis- | | (triethanol- | | | | | | | | | |
| | | persion | | aminate) | | | | | | | | | |
| | | Treat- | | | | | | | | | | | |
| | | ment | | | | | | | | | | | |
| Exam- | Method | Ni | 0.2 | Titanium | Barium | — | — | Water | 60 | BaTiO₃ | 2 | 87 | ◯ |
| ple | 1 | Slurry | | diisopropoxybis | lactate | | | | | | | | |
| 1-6 | | by Dis- | | (triethanol- | | | | | | | | | |
| | | persion | | aminate) | | | | | | | | | |
| | | Treat- | | | | | | | | | | | |
| | | ment | | | | | | | | | | | |
| Compar- | — | Ni | 0.2 | — | — | — | — | — | — | — | — | 44 | X |
| ative | | | | | | | | | | | | | |
| Exam- | | | | | | | | | | | | | |
| ple | | | | | | | | | | | | | |
| 1-1 | | | | | | | | | | | | | |
| Compar- | Method | Ni | 0.2 | Titanium | Barium | — | — | Acetone | 60 | BaTiO₃ | 2 | 71 | Δ |
| ative | 2 | | | tetraisopropoxide | diisoprop- | | | | | | | | |
| Exam- | | | | | oxide | | | | | | | | |
| ple | | | | | | | | | | | | | |
| 1-2 | | | | | | | | | | | | | |
| Compar- | Method | Ni | 0.2 | Titanium | — | — | — | Water | 60 | BaTiO₃ | 2 | 53 | X |
| ative | 3 | | | sulfate | | | | | | | | | |
| Exam- | | | | | | | | | | | | | |
| ple | | | | | | | | | | | | | |
| 1-3 | | | | | | | | | | | | | |
| Compar- | Method | Ni | 0.2 | Titanium | Barium | — | — | Butanol | 60 | BaTiO₃ | 2 | 68 | X |
| ative | 4 | | | chloride | chloride | | | | | | | | |
| Exam- | | | | | | | | | | | | | |
| ple | | | | | | | | | | | | | |
| 1-4 | | | | | | | | | | | | | |

As can be seen from the results in Table 1, Example 1-1 to Example 1-6 using the method 1 described above have achieved higher coverages of 80% or more, as compared with Comparative Example 1-1 to Comparative Example 1-4 using the method 2 to method 4 described above.

In Example 1-1 to Example 1-6, the use of the water-soluble metal compound allows the hydrolysis reaction (oxide coating reaction) to proceed gradually, thus keeping the metal oxide from produced at sites other than the surface of the metal particles in the solution, and providing metal particles with homogeneous oxide film. Furthermore, the step of forming the oxide coating film and the step of turning into the composite oxide are separated, thus providing highly homogeneous composite oxide coating films.

Comparative Example 1-1 is low in coverage without sintering suppression effect, because the metal powder is not covered with composite oxide.

Comparative Example 1-2 has, because of using the metal alkoxide extremely likely to be hydrolyzed, difficulty with reaction control, thereby making a metal oxide likely to be produced at sites other than metal particle surface in the solution before forming a metal particle coating film. In addition, the step of coating with the oxide and the step of turning into the composite oxide are simultaneously carried out, thus causing a reaction of producing a composite oxide at sites other than the metal particle surface. For this reason, the coating layer of the composite oxide undergoes a decrease in homogeneity, thereby decreasing the sintering suppression effect, and resulting in a lower coverage than in the examples.

Comparative Example 1-3 and Comparative Example 1-4 has metal oxides produced not only on the surfaces of the metal particles, but also at sites other than the metal particle surface in the solution, because of the rapid reactions of the metal salts with the alkalis. For this reason, the generation of inhomogeneous coating films has resulted in failure to achieve high coverages.

In order to further improve the homogeneity of the composite oxide coating layers, it is desirable to use metal slurry of a metal powder and an aqueous solvent subjected to dispersion treatment, as in Example 1-4 to Example 1-6. The method for the dispersion treatment is not particularly limited. In addition, for the dispersion treatment, a dispersant or the like may be used in order to improve dispersibility.

### Example 2-1 to Example 2-7

In Example 2-1 to Example 2-7, the temperature for turning TiO₂ as an oxide into BaTiO₃ as a composite oxide in the production method according to Example 1-1 was adjusted to 25, 40, 60, 80, 120, 200, and 300° C. to prepare composite oxide-coated metal powders. When the reaction temperature of the reaction for turning into composite oxide was the boiling point of the solvent or higher, an autoclave reactor was used. Table 2 shows the materials used in the respective production methods according to Example 2-1 to Example 2-7, and the results of evaluating the metal powders obtained from the materials.

TABLE 2

| | | | | | | Minute | Step | | | | | | |
|---|---|---|---|---|---|---|---|---|---|---|---|---|---|
| | | Type | | | | Amount of | of | Solvent | | Type | Com- | | Cov- |
| | | of | | | | Additive | Adding | of | | of | posite | | erage |
| | | Metal | Metal | Group IV | Group | Element | Rare- | Metal | Temper- | Com- | Oxide | Cov- | Deter- |
| | Coating | Par- | Particle | Metal | II | Rare Earth | earth | Powder | ature | posite | Content | erage | mina- |
| | Method | ticle | Size (μm) | Compound | Element | Mn, Si, V | Element | Slurry | (° C.) | Oxide | (mol %) | (%) | tion |
| Exam- | Method | Ni | 0.2 | Titanium | Barium | — | — | Water | 25 | BaTiO₃ | 2 | 72 | Δ |
| ple | 1 | | | diisopropoxybis | hydroxide | | | | | | | | |
| 2-1 | | | | (triethanol- | | | | | | | | | |
| | | | | aminate) | | | | | | | | | |
| Exam- | Method | Ni | 0.2 | Titanium | Barium | — | — | Water | 40 | BaTiO₃ | 2 | 79 | Δ |
| ple | 1 | | | diisopropoxybis | hydroxide | | | | | | | | |
| 2-2 | | | | (triethanol- | | | | | | | | | |
| | | | | aminate) | | | | | | | | | |
| Exam- | Method | Ni | 0.2 | Titanium | Barium | — | — | Water | 60 | BaTiO₃ | 2 | 86 | ◯ |
| ple | 1 | | | diisopropoxybis | hydroxide | | | | | | | | |
| 2-3 | | | | (triethanol- | | | | | | | | | |
| | | | | aminate) | | | | | | | | | |
| Exam- | Method | Ni | 0.2 | Titanium | Barium | — | — | Water | 80 | BaTiO₃ | 2 | 90 | ⊙ |
| ple | 1 | | | diisopropoxybis | hydroxide | | | | | | | | |
| 2-4 | | | | (triethanol- | | | | | | | | | |
| | | | | aminate) | | | | | | | | | |
| Exam- | Method | Ni | 0.2 | Titanium | Barium | — | — | Water | 120 | BaTiO₃ | 2 | 85 | ◯ |
| ple | 1 | | | diisopropoxybis | hydroxide | | | | | | | | |
| 2-5 | | | | (triethanol- | | | | | | | | | |
| | | | | aminate) | | | | | | | | | |
| Exam- | Method | Ni | 0.2 | Titanium | Barium | — | — | Water | 200 | BaTiO₃ | 2 | 89 | ◯ |
| ple | 1 | | | diisopropoxybis | hydroxide | | | | | | | | |
| 2-6 | | | | (triethanol- | | | | | | | | | |
| | | | | aminate) | | | | | | | | | |
| Exam- | Method | Ni | 0.2 | Titanium | Barium | — | — | Water | 300 | BaTiO₃ | 2 | 81 | ◯ |
| ple | 1 | | | diisopropoxybis | hydroxide | | | | | | | | |
| 2-7 | | | | (triethanol- | | | | | | | | | |
| | | | | aminate) | | | | | | | | | |

As can be seen from the results in Table 2, as long as the temperature of the reaction for turning into the composite oxide is a temperature of 60° C. or higher, the reaction proceeds sufficiently, and the decrease in coverage can be suppressed to achieve a high coverage. In addition, the reaction is desirably developed at a higher temperature in order to obtain a highly crystalline composite oxide.

### Example 3-1 to Example 3-8

In Example 3-1 to Example 3-8, the combination of the type of the water-soluble metal compound of the tetravalent metal element and the type of the divalent element in the production method according to Example 1-1 was varied to prepare composite oxide-coated metal powders. Table 3 shows the materials used in the respective production methods according to Example 3-1 to Example 3-8, and the results of evaluating the metal powders obtained from the materials.

TABLE 3

| | | | | | | Minute | Step | | | | | | |
|---|---|---|---|---|---|---|---|---|---|---|---|---|---|
| | | Type | | | | Amount of | of | Solvent | | Type | Com- | | Cov- |
| | | of | Metal | | | Additive | Adding | of | | of | posite | | erage |
| | | Metal | Particle | Group IV | Group | Element | Rare- | Metal | Temper- | Com- | Oxide | Cov- | Deter- |
| | Coating | Par- | Size | Metal | II | Rare Earth | earth | Powder | ature | posite | Content | erage | mina- |
| | Method | ticle | (μm) | Compound | Element | Mn, Si, V | Element | Slurry | (° C.) | Oxide | (mol %) | (%) | tion |
| Exam- | Method | Ni | 0.2 | Zirconyl | Calcium | — | — | Water | 60 | CaZrO₃ | 2 | 85 | ◯ |
| ple | 1 | | | Chloride- | chloride | | | | | | | | |
| 3-1 | | | | Aminocarboxylic | | | | | | | | | |
| | | | | Acid | | | | | | | | | |
| Exam- | Method | Ni | 0.2 | Titanium | Magnesium | — | — | Water | 60 | MgTiO₃ | 2 | 89 | ◯ |
| ple | 1 | | | diisopropoxybis | chloride | | | | | | | | |
| 3-2 | | | | (triethanol- | | | | | | | | | |
| | | | | aminate) | | | | | | | | | |
| Exam- | Method | Ni | 0.2 | Zirconyl | Magnesium | — | — | Water | 60 | MgZrO₃ | 2 | 81 | ◯ |
| ple | 1 | | | Chloride- | chloride | | | | | | | | |
| 3-3 | | | | Aminocarboxylic | | | | | | | | | |
| | | | | Acid | | | | | | | | | |
| Exam- | Method | Ni | 0.2 | Titanium | Calcium | — | — | Water | 60 | CaTiO₃ | 2 | 81 | ◯ |
| ple | 1 | | | diisopropoxybis | chloride | | | | | | | | |
| 3-4 | | | | (triethanol- | | | | | | | | | |
| | | | | aminate) | | | | | | | | | |
| Exam- | Method | Ni | 0.2 | Titanium | Strontium | — | — | Water | 60 | SrTiO₃ | 2 | 79 | Δ |
| ple | 1 | | | diisopropoxybis | chloride | | | | | | | | |
| 3-5 | | | | (triethanol- | | | | | | | | | |
| | | | | aminate) | | | | | | | | | |
| Exam- | Method | Ni | 0.2 | Zirconyl | Strontium | — | — | Water | 60 | SrZrO₃ | 2 | 87 | ◯ |
| ple | 1 | | | Chloride- | chloride | | | | | | | | |
| 3-6 | | | | Aminocarboxylic | | | | | | | | | |
| | | | | Acid | | | | | | | | | |
| Exam- | Method | Ni | 0.2 | Titanium | Barium | — | — | Water | 60 | BaTiO₃ | 2 | 88 | ◯ |
| ple | 1 | | | diisopropoxybis | hydroxide | | | | | | | | |
| 3-7 | | | | (triethanol- | | | | | | | | | |
| | | | | aminate) | | | | | | | | | |
| Exam- | Method | Ni | 0.2 | Zirconyl | Barium | — | — | Water | 60 | BaZrO₃ | 2 | 80 | ◯ |
| ple | 1 | | | Chloride- | hydroxide | | | | | | | | |
| 3-8 | | | | Aminocarboxylic | | | | | | | | | |
| | | | | Acid | | | | | | | | | |

From the results in Table 3, it has been confirmed that high-coverage multilayer capacitors can be manufactured by forming composite oxides of MgTiO₃, MgZrO₃, CaTiO₃, CaZrO₃, BaTiO₃, BaZrO₃, SrTiO₃, and SrZrO₃.

Multilayer ceramic capacitors use dielectrics of various compositions.

Composite oxides added for sintering suppression may transfer to dielectric layers during firing to deteriorate component characteristics. The selection of an appropriate coating composition depending on the composition of the dielectric layers from among composite oxides of MgTiO₃, MgZrO₃, CaTiO₃, CaZrO₃, BaTiO₃, BaZrO₃, SrTiO₃, and SrZrO₃ makes it possible to maintain component characteristics of the multilayer ceramic capacitors.

In addition, Ti and Zr are more likely to form composite oxides that have a perovskite structure with a high dielectric constant. While any compound can be used as the water-soluble metal compound of the tetravalent metal element, metal compounds are desired which have a coordinate hydroxycarboxylic acid, aminoalcohol, or aminocarboxylic acid. Typical examples of titanium compounds taken as an example of the metal compound include, but not limited to, titanium diisopropoxybis(triethanolaminate) and titanium lactate.

The composition of the composite oxide may be based on any of MgTiO₃, MgZrO₃, CaTiO₃, CaZrO₃, BaTiO₃, BaZrO₃, SrTiO₃, and SrZrO₃, containing an element such as B, Si, P, S, Cr, Fe, Co, Ni, Cu, and Zn.

### Example 4-1 to Example 4-18

In Example 4-1 to Example 4-18, composite oxide-coated metal powders were prepared through the addition of at least one rare-earth element in minute amounts in adding the water-soluble metal compound of the tetravalent metal element in the first step, or adding the solution containing the divalent element in the second step in the production method according to Example 1-1. Table 4 shows the materials used in the respective production methods according to Example 4-1 to Example 4-18, and the results of evaluating the metal powders obtained from the materials.

TABLE 4

| | | | | | | Minute | Step | | | | | | |
|---|---|---|---|---|---|---|---|---|---|---|---|---|---|
| | | Type | | | | Amount of | of | Solvent | | Type | Com- | | Cov- |
| | | of | Metal | | | Additive | Adding | of | | of | posite | | erage |
| | | Metal | Particle | Group IV | Group | Element | Rare- | Metal | Temper- | Com- | Oxide | Cov- | Deter- |
| | Coating | Par- | Size | Metal | II | Rare Earth | earth | Powder | ature | posite | Content | erage | mina- |
| | Method | ticle | (μm) | Compound | Element | Mn, Si, V | Element | Slurry | (° C.) | Oxide | (mol %) | (%) | tion |
| Exam- | Method | Ni | 0.2 | Titanium | Barium | Scandium | Step 1 | Water | 60 | BaTiO₃ | 2 | 87 | ◯ |
| ple | 1 | | | diisopropoxybis | hydroxide | chloride | | | | | | | |
| 4-1 | | | | (triethanol- | | | | | | | | | |
| | | | | aminate) | | | | | | | | | |
| Exam- | Method | Ni | 0.2 | Titanium | Barium | Scandium | Step 2 | Water | 60 | BaTiO₃ | 2 | 92 | ⊙ |
| ple | 1 | | | diisopropoxybis | hydroxide | chloride | | | | | | | |
| 4-2 | | | | (triethanol- | | | | | | | | | |
| | | | | aminate) | | | | | | | | | |
| Exam- | Method | Ni | 0.2 | Titanium | Barium | Yttrium | Step 1 | Water | 60 | BaTiO₃ | 2 | 93 | ⊙ |
| ple | 1 | | | diisopropoxybis | hydroxide | chloride | | | | | | | |
| 4-3 | | | | (triethanol- | | | | | | | | | |
| | | | | aminate) | | | | | | | | | |
| Exam- | Method | Ni | 0.2 | Titanium | Barium | Lanthanum | Step 1 | Water | 60 | BaTiO₃ | 2 | 90 | ⊙ |
| ple | 1 | | | diisopropoxybis | hydroxide | chloride | | | | | | | |
| 4-4 | | | | (triethanol- | | | | | | | | | |
| | | | | aminate) | | | | | | | | | |
| Exam- | Method | Ni | 0.2 | Titanium | Barium | Cerium | Step 1 | Water | 60 | BaTiO₃ | 2 | 85 | ◯ |
| ple | 1 | | | diisopropoxybis | hydroxide | chloride | | | | | | | |
| 4-5 | | | | (triethanol- | | | | | | | | | |
| | | | | aminate) | | | | | | | | | |
| Exam- | Method | Ni | 0.2 | Titanium | Barium | Praseodymium | Step 1 | Water | 60 | BaTiO₃ | 2 | 94 | ⊙ |
| ple | 1 | | | diisopropoxybis | hydroxide | chloride | | | | | | | |
| 4-6 | | | | (triethanol- | | | | | | | | | |
| | | | | aminate) | | | | | | | | | |
| Exam- | Method | Ni | 0.2 | Titanium | Barium | Neodymium | Step 1 | Water | 60 | BaTiO₃ | 2 | 94 | ⊙ |
| ple | 1 | | | diisopropoxybis | hydroxide | chloride | | | | | | | |
| 4-7 | | | | (triethanol- | | | | | | | | | |
| | | | | aminate) | | | | | | | | | |
| Exam- | Method | Ni | 0.2 | Titanium | Barium | Samarium | Step 1 | Water | 60 | BaTiO₃ | 2 | 96 | ⊙ |
| ple | 1 | | | diisopropoxybis | hydroxide | chloride | | | | | | | |
| 4-8 | | | | (triethanol- | | | | | | | | | |
| | | | | aminate) | | | | | | | | | |
| Exam- | Method | Ni | 0.2 | Titanium | Barium | Europium | Step 1 | Water | 60 | BaTiO₃ | 2 | 88 | ◯ |
| ple | 1 | | | diisopropoxybis | hydroxide | chloride | | | | | | | |
| 4-9 | | | | (triethanol- | | | | | | | | | |
| | | | | aminate) | | | | | | | | | |
| Exam- | Method | Ni | 0.2 | Titanium | Barium | Gadolinium | Step 1 | Water | 60 | BaTiO₃ | 2 | 89 | ◯ |
| ple | 1 | | | diisopropoxybis | hydroxide | chloride | | | | | | | |
| 4-10 | | | | (triethanol- | | | | | | | | | |
| | | | | aminate) | | | | | | | | | |
| Exam- | Method | Ni | 0.2 | Titanium | Barium | Terbium | Step 1 | Water | 60 | BaTiO₃ | 2 | 88 | ◯ |
| ple | 1 | | | diisopropoxybis | hydroxide | chloride | | | | | | | |
| 4-11 | | | | (triethanol- | | | | | | | | | |
| | | | | aminate) | | | | | | | | | |
| Exam- | Method | Ni | 0.2 | Titanium | Barium | Dysprosium | Step 1 | Water | 60 | BaTiO₃ | 2 | 95 | ⊙ |
| ple | 1 | | | diisopropoxybis | hydroxide | chloride | | | | | | | |
| 4-12 | | | | (triethanol- | | | | | | | | | |
| | | | | aminate) | | | | | | | | | |
| Exam- | Method | Ni | 0.2 | Titanium | Barium | Holmium | Step 1 | Water | 60 | BaTiO₃ | 2 | 92 | ⊙ |
| ple | 1 | | | diisopropoxybis | hydroxide | chloride | | | | | | | |
| 4-13 | | | | (triethanol- | | | | | | | | | |
| | | | | aminate) | | | | | | | | | |
| Exam- | Method | Ni | 0.2 | Titanium | Barium | Erbium | Step 1 | Water | 60 | BaTiO₃ | 2 | 96 | ⊙ |
| ple | 1 | | | diisopropoxybis | hydroxide | chloride | | | | | | | |
| 4-14 | | | | (triethanol- | | | | | | | | | |
| | | | | aminate) | | | | | | | | | |
| Exam- | Method | Ni | 0.2 | Titanium | Barium | Thulium | Step 1 | Water | 60 | BaTiO₃ | 2 | 94 | ⊙ |
| ple | 1 | | | diisopropoxybis | hydroxide | chloride | | | | | | | |
| 4-15 | | | | (triethanol- | | | | | | | | | |
| | | | | aminate) | | | | | | | | | |
| Exam- | Method | Ni | 0.2 | Titanium | Barium | Ytterbium | Step 1 | Water | 60 | BaTiO₃ | 2 | 94 | ⊙ |
| ple | 1 | | | diisopropoxybis | hydroxide | chloride | | | | | | | |
| 4-16 | | | | (triethanol- | | | | | | | | | |
| | | | | aminate) | | | | | | | | | |
| Exam- | Method | Ni | 0.2 | Titanium | Barium | Lutetium | Step 1 | Water | 60 | BaTiO₃ | 2 | 92 | ⊙ |
| ple | 1 | | | diisopropoxybis | hydroxide | chloride | | | | | | | |
| 4-17 | | | | (triethanol- | | | | | | | | | |
| | | | | aminate) | | | | | | | | | |
| Exam- | Method | Ni | 0.2 | Titanium | Barium | Yttrium | Step 1 | Water | 60 | BaTiO₃ | 2 | 96 | ⊙ |
| ple | 1 | | | diisopropoxybis | hydroxide | chloride | | | | | | | |
| 4-18 | | | | (triethanol- | | Dysprosium | | | | | | | |
| | | | | aminate) | | chloride | | | | | | | |

From the results in Table 4, it has been confirmed that even when the rare-earth element is introduced, it is possible to produce composite oxide-coated metal powders coated uniformly with composite oxides, thereby keeping the coverages from being decreased.

Additives such as rare-earth elements are introduced into dielectric layers in order to improve characteristics of electronic components. On the other hand, composite oxide constituents of electrode layers transfer to the dielectric layers in the process of sintering, and the dielectric component may be thus shifted to deteriorate electronic component characteristics. In the present examples, because of the rare-earth element introduced into the composite oxide layers while maintaining the homogeneity of the composite oxide layers coating the metal powders, electronic component characteristics can be maintained without any composition shift after firing. Furthermore, the rare-earth element contained in the composite oxide layers increases the sintering temperatures of the composite oxides, thus improving the sintering suppression effect, and allowing high coverages to be achieved.

### Example 5-1 to Example 5-6

In Example 5-1 to Example 5-6, metal powders were prepared by varying the additive amounts of; the water-soluble metal compound of the tetravalent metal element; and the divalent element to vary the content of the composite compound formed in the production method according to Example 1-1. Table 5 shows the materials used in the respective production methods according to Example 5-1 to Example 5-6, and the results of evaluating the metal powders obtained from the materials.

TABLE 5

| | | | | | | Minute | Step | | | | | | |
|---|---|---|---|---|---|---|---|---|---|---|---|---|---|
| | | Type | | | | Amount of | of | Solvent | | Type | Com- | | Cov- |
| | | of | Metal | | | Additive | Adding | of | | of | posite | | erage |
| | | Metal | Particle | Group IV | Group | Element | Rare- | Metal | Temper- | Com- | Oxide | Cov- | Deter- |
| | Coating | Par- | Size | Metal | II | Rare Earth | earth | Powder | ature | posite | Content | erage | mina- |
| | Method | ticle | (μm) | Compound | Element | Mn, Si, V | Element | Slurry | (° C.) | Oxide | (mol %) | (%) | tion |
| Exam- | Method | Ni | 0.2 | Titanium | Barium | — | — | Water | 60 | BaTiO₃ | 0.1 | 77 | Δ |
| ple | 1 | | | diisopropoxybis | hydroxide | | | | | | | | |
| 5-1 | | | | (triethanol- | | | | | | | | | |
| | | | | aminate) | | | | | | | | | |
| Exam- | Method | Ni | 0.2 | Titanium | Barium | — | — | Water | 60 | BaTiO₃ | 0.5 | 82 | ◯ |
| ple | 1 | | | diisopropoxybis | hydroxide | | | | | | | | |
| 5-2 | | | | (triethanol- | | | | | | | | | |
| | | | | aminate) | | | | | | | | | |
| Exam- | Method | Ni | 0.2 | Titanium | Barium | — | — | Water | 60 | BaTiO₃ | 1 | 85 | ◯ |
| ple | 1 | | | diisopropoxybis | hydroxide | | | | | | | | |
| 5-3 | | | | (triethanol- | | | | | | | | | |
| | | | | aminate) | | | | | | | | | |
| Exam- | Method | Ni | 0.2 | Titanium | Barium | — | — | Water | 60 | BaTiO₃ | 2 | 86 | ◯ |
| ple | 1 | | | diisopropoxybis | hydroxide | | | | | | | | |
| 5-4 | | | | (triethanol- | | | | | | | | | |
| | | | | aminate) | | | | | | | | | |
| Exam- | Method | Ni | 0.2 | Titanium | Barium | — | — | Water | 60 | BaTiO₃ | 10 | 83 | ◯ |
| ple | 1 | | | diisopropoxybis | hydroxide | | | | | | | | |
| 5-5 | | | | (triethanol- | | | | | | | | | |
| | | | | aminate) | | | | | | | | | |
| Exam- | Method | Ni | 0.2 | Titanium | Barium | — | — | Water | 60 | BaTiO₃ | 20 | 72 | Δ |
| ple | 1 | | | diisopropoxybis | hydroxide | | | | | | | | |
| 5-6 | | | | (triethanol- | | | | | | | | | |
| | | | | aminate) | | | | | | | | | |

From the results in Table 5, it has been confirmed that the content of the composite oxide formation from 0.5 to 10.0 mol % further improves the sintering suppression effect, thereby achieving high coverages.

### Example 6-1 to Example 6-6

In Example 6-1 to Example 6-6, composite oxide-coated metal powders were prepared by varying the metal powder in particle size under the condition of the conductive coating film adjusted to 1.0 μm in metal film thickness in the production method according to Example 1-1. In addition, as comparative examples, metal powders coated with no composite oxide besides under the condition of varying the metal powder in particle size were also prepared in a similar manner. Table 6 shows the materials used in the respective production methods according to Example 6-1 to Example 6-6 and Comparative Example 6-1 to Comparative Example 6-6, and the results of evaluating the metal powders obtained from the materials.

TABLE 6

| | | | | | | Minute | Step | | | | | | |
|---|---|---|---|---|---|---|---|---|---|---|---|---|---|
| | | Type | | | | Amount of | of | Solvent | | Type | Com- | | Cov- |
| | | of | Metal | | | Additive | Adding | of | | of | posite | | erage |
| | | Metal | Particle | Group IV | Group | Element | Rare- | Metal | Temper- | Com- | Oxide | Cov- | Deter- |
| | Coating | Par- | Size | Metal | II | Rare Earth | earth | Powder | ature | posite | Content | erage | mina- |
| | Method | ticle | (μm) | Compound | Element | Mn, Si, V | Element | Slurry | (° C.) | Oxide | (mol %) | (%) | tion |
| Exam- | Method | Ni | 0.01 | Titanium | Barium | — | — | Water | 60 | BaTiO₃ | 2 | 77 | Δ |
| ple | 1 | | | diisopropoxybis | hydroxide | | | | | | | | |
| 6-1 | | | | (triethanol- | | | | | | | | | |
| | | | | aminate) | | | | | | | | | |
| Exam- | Method | Ni | 0.05 | Titanium | Barium | — | — | Water | 60 | BaTiO₃ | 2 | 82 | ◯ |
| ple | 1 | | | diisopropoxybis | hydroxide | | | | | | | | |
| 6-2 | | | | (triethanol- | | | | | | | | | |
| | | | | aminate) | | | | | | | | | |
| Exam- | Method | Ni | 0.1 | Titanium | Barium | — | — | Water | 60 | BaTiO₃ | 2 | 86 | ◯ |
| ple | 1 | | | diisopropoxybis | hydroxide | | | | | | | | |
| 6-3 | | | | (triethanol- | | | | | | | | | |
| | | | | aminate) | | | | | | | | | |
| Exam- | Method | Ni | 0.2 | Titanium | Barium | — | — | Water | 60 | BaTiO₃ | 2 | 86 | ◯ |
| ple | 1 | | | diisopropoxybis | hydroxide | | | | | | | | |
| 6-4 | | | | (triethanol- | | | | | | | | | |
| | | | | aminate) | | | | | | | | | |
| Exam- | Method | Ni | 0.5 | Titanium | Barium | — | — | Water | 60 | BaTiO₃ | 2 | 87 | ◯ |
| ple | 1 | | | diisopropoxybis | hydroxide | | | | | | | | |
| 6-5 | | | | (triethanol- | | | | | | | | | |
| | | | | aminate) | | | | | | | | | |
| Exam- | Method | Ni | 1 | Titanium | Barium | — | — | Water | 60 | BaTiO₃ | 2 | 73 | Δ |
| ple | 1 | | | diisopropoxybis | hydroxide | | | | | | | | |
| 6-6 | | | | (triethanol- | | | | | | | | | |
| | | | | aminate) | | | | | | | | | |
| Compar- | — | Ni | 0.01 | — | — | — | — | — | — | — | — | 66 | X |
| ative | | | | | | | | | | | | | |
| Exam- | | | | | | | | | | | | | |
| ple | | | | | | | | | | | | | |
| 6-1 | | | | | | | | | | | | | |
| Compar- | — | Ni | 0.05 | — | — | — | — | — | — | — | — | 60 | X |
| ative | | | | | | | | | | | | | |
| Exam- | | | | | | | | | | | | | |
| ple | | | | | | | | | | | | | |
| 6-2 | | | | | | | | | | | | | |
| Compar- | — | Ni | 0.1 | — | — | — | — | — | — | — | — | 63 | X |
| ative | | | | | | | | | | | | | |
| Exam- | | | | | | | | | | | | | |
| ple | | | | | | | | | | | | | |
| 6-3 | | | | | | | | | | | | | |
| Compar- | — | Ni | 0.2 | — | — | — | — | — | — | — | — | 68 | X |
| ative | | | | | | | | | | | | | |
| Exam- | | | | | | | | | | | | | |
| ple | | | | | | | | | | | | | |
| 6-4 | | | | | | | | | | | | | |
| Compar- | — | Ni | 0.5 | — | — | — | — | — | — | — | — | 63 | X |
| ative | | | | | | | | | | | | | |
| Exam- | | | | | | | | | | | | | |
| ple | | | | | | | | | | | | | |
| 6-5 | | | | | | | | | | | | | |
| Compar- | — | Ni | 1 | — | — | — | — | — | — | — | — | 55 | X |
| ative | | | | | | | | | | | | | |
| Exam- | | | | | | | | | | | | | |
| ple | | | | | | | | | | | | | |
| 6-6 | | | | | | | | | | | | | |

From the results in Table 6, the coverage improved by coating with the composite oxide has been confirmed in any case where the metal powder falls within the range of 0.01 to 1 μm in particle size.

### Example 7-1 to Example 7-4

In Example 7-1 to Example 7-4, composite oxide-coated metal powders were prepared by varying the metal composition of the metal powder in the production method according to Example 1-1. In addition, as comparative examples, metal powders coated with no composite oxide were also prepared in a similar manner. Table 7 shows the materials used in the respective production methods according to Example 7-1 to Example 7-4 and Comparative Example 7-1 to Comparative Example 7-4, and the results of evaluating the metal powders obtained from the materials.

TABLE 7

| | | | | | | Minute | Step | | | | | | |
|---|---|---|---|---|---|---|---|---|---|---|---|---|---|
| | | Type | | | | Amount of | of | Solvent | | Type | Com- | | Cov- |
| | | of | Metal | | | Additive | Adding | of | | of | posite | | erage |
| | | Metal | Particle | Group IV | Group | Element | Rare- | Metal | Temper- | Com- | Oxide | Cov- | Deter- |
| | Coating | Par- | Size | Metal | II | Rare Earth | earth | Powder | ature | posite | Content | erage | mina- |
| | Method | ticle | (μm) | Compound | Element | Mn, Si, V | Element | Slurry | (° C.) | Oxide | (mol %) | (%) | tion |
| Exam- | Method | Ni | 0.2 | Titanium | Barium | — | — | Water | 60 | BaTiO₃ | 2 | 86 | ◯ |
| ple | 1 | | | diisopropoxybis | hydroxide | | | | | | | | |
| 7-1 | | | | (triethanol- | | | | | | | | | |
| | | | | aminate) | | | | | | | | | |
| Exam- | Method | Ag | 0.2 | Titanium | Barium | — | — | Water | 60 | BaTiO₃ | 2 | 80 | ◯ |
| ple | 1 | | | diisopropoxybis | hydroxide | | | | | | | | |
| 7-2 | | | | (triethanol- | | | | | | | | | |
| | | | | aminate) | | | | | | | | | |
| Exam- | Method | Pd | 0.2 | Titanium | Barium | — | — | Water | 60 | BaTiO₃ | 2 | 85 | ◯ |
| ple | 1 | | | diisopropoxybis | hydroxide | | | | | | | | |
| 7-3 | | | | (triethanol- | | | | | | | | | |
| | | | | aminate) | | | | | | | | | |
| Exam- | Method | Cu | 0.2 | Titanium | Barium | — | — | Water | 60 | BaTiO₃ | 2 | 89 | ◯ |
| ple | 1 | | | diisopropoxybis | hydroxide | | | | | | | | |
| 7-4 | | | | (triethanol- | | | | | | | | | |
| | | | | aminate) | | | | | | | | | |
| Compar- | — | Ni | 0.2 | — | — | — | — | — | — | — | — | 44 | X |
| ative | | | | | | | | | | | | | |
| Exam- | | | | | | | | | | | | | |
| ple | | | | | | | | | | | | | |
| 7-1 | | | | | | | | | | | | | |
| Compar- | — | Ag | 0.2 | — | — | — | — | — | — | — | — | 45 | X |
| ative | | | | | | | | | | | | | |
| Exam- | | | | | | | | | | | | | |
| ple | | | | | | | | | | | | | |
| 7-2 | | | | | | | | | | | | | |
| Compar- | — | Pd | 0.2 | — | — | — | — | — | — | — | — | 45 | X |
| ative | | | | | | | | | | | | | |
| Exam- | | | | | | | | | | | | | |
| ple | | | | | | | | | | | | | |
| 7-3 | | | | | | | | | | | | | |
| Compar- | — | Cu | 0.2 | — | — | — | — | — | — | — | — | 40 | X |
| ative | | | | | | | | | | | | | |
| Exam- | | | | | | | | | | | | | |
| ple | | | | | | | | | | | | | |
| 7-4 | | | | | | | | | | | | | |

From the results in Table 7, improvements in coverage by sintering suppression have been confirmed even in the case of the metal powders other than the nickel powder. For this reason, the metal powders produced by the production method according to the present invention are allowed to be used in various electronic components.

### Example 8-1 to Example 8-6

In Example 8-1 to Example 8-6, composite oxide-coated metal powders were prepared with the use of nickel powders in which the ratio of the metal element in a hydroxide state was 8 to 96% at surface layers.

It is to be noted that the ratio of the metal element in a hydroxide state was calculated by peak separation of the metal element in terms of metal state, oxide state and hydroxide state from binding energy values of Ni 2p 3/2 peaks in XPS. The peaks of Ni in a metal state, Ni in an oxide state, and Ni in a hydroxide state appear respectively at 852.7 eV, 853.8 eV, and 855.1 eV. Table 8 shows the materials used in the respective production methods according to Example 8-1 to Example 8-6, and the results of evaluating the metal powders obtained from the materials.

TABLE 8

| | | | | | | | | | | | | |
|---|---|---|---|---|---|---|---|---|---|---|---|---|
| | | | | | Minute | Step | | | | | | |
| | Type | | | | Amount of | of | Solvent | | Type | Com- | | Cov- |
| | of | Metal | | | Additive | Adding | of | | of | posite | | erage |
| | Metal | Particle | Group IV | Group | Element | Rare- | Metal | Temper- | Com- | Oxide | Cov- | Deter- |
| Coating | Par- | Size | Metal | II | Rare Earth | earth | Powder | ature | posite | Content | erage | mina- |
| Method | ticle | (μm) | Compound | Element | Mn, Si, V | Element | Slurry | (° C.) | Oxide | (mol %) | (%) | tion |

| | | | | | | | | | | | | |
|---|---|---|---|---|---|---|---|---|---|---|---|---|
| Exam- | Method | Ni | 0.2 | Titanium | Barium | 8 | Water | 60 | BaTiO₃ | 2 | 82 | ◯ |
| ple | 1 | | | diisopropoxybis | hydroxide | | | | | | | |
| 8-1 | | | | (triethanol- | | | | | | | | |
| | | | | aminate) | | | | | | | | |
| Exam- | Method | Ni | 0.2 | Titanium | Barium | 19 | Water | 60 | BaTiO₃ | 2 | 86 | ◯ |
| ple | 1 | | | diisopropoxybis | hydroxide | | | | | | | |
| 8-2 | | | | (triethanol- | | | | | | | | |
| | | | | aminate) | | | | | | | | |
| Exam- | Method | Ni | 0.2 | Titanium | Barium | 31 | Water | 60 | BaTiO₃ | 2 | 92 | ⊙ |
| ple | 1 | | | diisopropoxybis | hydroxide | | | | | | | |
| 8-3 | | | | (triethanol- | | | | | | | | |
| | | | | aminate) | | | | | | | | |
| Exam- | Method | Ni | 0.2 | Titanium | Barium | 54 | Water | 60 | BaTiO₃ | 2 | 92 | ⊙ |
| ple | 1 | | | diisopropoxybis | hydroxide | | | | | | | |
| 8-4 | | | | (triethanol- | | | | | | | | |
| | | | | aminate) | | | | | | | | |
| Exam- | Method | Ni | 0.2 | Titanium | Barium | 71 | Water | 60 | BaTiO₃ | 2 | 94 | ⊙ |
| ple | 1 | | | diisopropoxybis | hydroxide | | | | | | | |
| 8-5 | | | | (triethanol- | | | | | | | | |
| | | | | aminate) | | | | | | | | |
| Exam- | Method | Ni | 0.2 | Titanium | Barium | 96 | Water | 60 | BaTiO₃ | 2 | 91 | ⊙ |
| ple | 1 | | | diisopropoxybis | hydroxide | | | | | | | |
| 8-6 | | | | (triethanol- | | | | | | | | |
| | | | | aminate) | | | | | | | | |

From the results in Table 8, further improvements in coverage have been confirmed when the ratio of Ni in a hydroxide state falls within the range of 31% to 96%. From the foregoing, the surface hydroxide can be considered to cause the hydrolysis reaction of the water-soluble metal compound to proceed at the surface in a more selective manner, thereby forming a more homogeneous oxide-coated film.

While the coating film of the composite oxide of the tetravalent metal element and divalent metal element was formed at the metal powder surface to achieve improvements in coverage in the examples related to the production method according to the present invention, it is believed to be basically possible to achieve a similar effect as long as the coating film is an oxide film with a high melting point. Accordingly, even in the case of composite oxides composed of elements with valences other than those above, similar effects are believed to be achieved.

### DESCRIPTION OF REFERENCE SYMBOLS

10 metal salt solution
12 metal powder
14 OH group at metal powder surface or OH near metal powder
20 water-soluble metal compound solution
22 water-soluble metal compound
42 metal oxide-coated metal powder
44 metal oxide
52 divalent element
72 composite oxide-coated metal powder
74 composite oxide

1. A method for producing a composite oxide-coated metal powder, the method comprising:
adding a water-soluble metal compound containing a tetravalent metal element to a first slurry including a metal powder having a metal element dispersed in a solvent including at least water so as to deposit a metal oxide containing the tetravalent metal element at least partially on a surface of the metal powder thereby providing a second slurry containing a metal oxide-coated metal powder; and
adding a solution or a powder containing at least one divalent element to the second slurry to react the metal oxide on the surface of the metal powder with the divalent element so as to produce the composite oxide-coated metal powder.

2. The method for producing a composite oxide-coated metal powder according to claim 1, wherein the metal powder has a ratio of the metal element in a hydroxide state within a range of 30% to 100%, the ratio being obtained by peak separation of the metal element in a metal state, the metal element in an oxide state, and the metal element in the hydroxide state in an X-ray photoelectron spectroscopy analysis.

3. The method for producing a composite oxide-coated metal powder according to claim 1, wherein the water-soluble metal compound is a chelate complex.

4. The method for producing a composite oxide-coated metal powder according to claim 1, wherein the water-soluble metal compound is a metal compound with at least one of a hydroxycarboxylic acid, an aminoalcohol, and an aminocarboxylic acid coordinate.

5. The method for producing a composite oxide-coated metal powder according to claim 1, wherein a temperature for reacting the metal oxide on the surface of the metal powder with the divalent element is 60° C. or higher.

6. The method for producing a composite oxide-coated metal powder according to claim 1, wherein the tetravalent metal element is Zr and/or Ti.

7. The method for producing a composite oxide-coated metal powder according to claim 1, wherein the divalent element contained in the solution or the powder includes at least one of Mg, Ca, Sr, and Ba.

8. The method for producing a composite oxide-coated metal powder according to claim 1, further comprising adding a second solution or a second powder containing at least one element of rare-earth elements, Mn, Si, and V to the metal powder to cause the at least one element of the rare-earth elements, the Mn, the Si, and the V to be contained in a composite oxide layer of the composite oxide-coated metal powder.

9. The method for producing a composite oxide-coated metal powder according to claim 1, wherein the step of adding the water-soluble metal compound containing the tetravalent metal element to the first slurry is carried out in a first step, and after the first step is completed, the step of adding the solution or the powder containing the at least one divalent element to the second slurry is carried out in a second step.

10. The method for producing a composite oxide-coated metal powder according to claim 9, wherein in at least one of the first step, the second step, and another step between the first step and the second step, the method further comprises adding a second solution or a second powder containing at least one element of rare-earth elements, Mn, Si, and V to the metal powder to cause the at least one element of the rare-earth elements, the Mn, the Si, and the V to be contained in a composite oxide layer of the composite oxide-coated metal powder.

11. The method for producing a composite oxide-coated metal powder according to claim 1, wherein a constituent ratio of a composite oxide of the composite oxide-coated metal powder is 0.5 mol % to 10 mol % when the metal powder is regarded as 100 mol %.

12. The method for producing a composite oxide-coated metal powder according to claim 1, wherein the metal powder is 0.01 μm to 1 μm in particle size.

13. The method for producing a composite oxide-coated metal powder according to claim 1, wherein the metal element in the metal powder includes at least one of Ni, Ag, Cu, and Pd.

14. The method for producing a composite oxide-coated metal powder according to claim 1, wherein the water-soluble metal compound containing the tetravalent metal element is in a second solution that is added to the first slurry.

15. The method for producing a composite oxide-coated metal powder according to claim 14, wherein the second solution contains 1 wt % to 40 wt % of the water-soluble metal compound.

16. The method for producing a composite oxide-coated metal powder according to claim 14, wherein the second solution is added in stages to the first slurry.

17. The method for producing a composite oxide-coated metal powder according to claim 16, wherein a concentration of the water-soluble metal compound in the second solution is different in each of the stages.

18. A composite oxide-coated metal powder produced by the production method according to claim 1.

19. A conductive paste comprising:
the composite oxide-coated metal powder according to claim 18; and
an organic vehicle.

20. A multilayer ceramic electronic component comprising a plurality of ceramic layers and internal electrode layers provided between the respective layers from the plurality of ceramic layers, wherein the internal electrode layers are obtained by sintering the conductive paste according to claim 19.
